(19) United States
(12) Patent Application Publication
(10) Pub. No.: US 2013/0082555 A1
(43) Pub. Date: Apr. 4, 2013

(54) SPINDLE MOTOR

(71) Applicant: Duck Young Kim, Gyunggi-do (KR)

(72) Inventor: Duck Young Kim, Gyunggi-do (KR)

(73) Assignee: SAMSUNG ELECTRO-MECHANICS CO., LTD., Gyunggi-do (KR)

(21) Appl. No.: 13/478,847

(22) Filed: May 23, 2012

(30) Foreign Application Priority Data
Sep. 30, 2011 (KR) 1020110100132

(51) Int. Cl. H02K 7/08

(52) U.S. Cl. 310/90

(57) ABSTRACT

Disclosed herein is a spindle motor in which oil sealing parts are surface-treated stepwise with respect to oil used as a fluid dynamic bearing, such that sealing of the oil sealing part is enhanced, thereby preventing scattering, or the like, of the oil. According to preferred embodiments of the present invention, oil contact surfaces are surface-treated stepwise in the direction from the inner side of the oil interface formed in the oil sealing part of a fluid dynamic bearing part toward the outer side thereof, thereby making it possible to enhance maintenance of the oil interface.

### CROSS REFERENCE TO RELATED APPLICATION

This application claims the benefit of Korean Patent Application No. 10-2011-0100132, filed on Sep. 30, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor, which belongs to a brushless-DC motor (BLDC), has been widely used as a laser beam scanner motor for a laser printer, a motor for a floppy disk drive (FDD), a motor for an optical disk drive such as a compact disk (CD) or a digital versatile disk (DVD), or the like, in addition to a motor for a hard disk drive.

Recently, in a device such as a hard disk drive requiring high capacity and high speed driving force, in order to minimize generation of noise and non repeatable run out (NRRO), which is vibration generated at the time of use of a ball bearing, a spindle motor including a fluid dynamic bearing having lower driving friction as compared to an existing ball bearing has generally been used. In the fluid dynamic bearing, a thin oil film is basically formed between a rotor and a stator, such that the rotor and the stator are supported by pressure generated at the time of rotation. Therefore, the rotor and stator are not in contact with each other, such that frictional load is reduced. In the spindle motor using the fluid dynamic bearing, lubricating oil (hereinafter, referred to as ‘operating fluid) maintains a shaft of the motor rotating a disk only with dynamic pressure (pressure returning oil pressure to the center by centrifugal force of the shaft). Therefore, the spindle motor using the fluid dynamic bearing is distinguished from a ball bearing spindle motor in that the shaft is supported by a shaft ball made of iron.

When the fluid dynamic bearing is used in the spindle motor, the rotor is supported by the fluid, such that a noise amount generated in the motor is small, power consumption is low, and impact resistance is excellent.

However, in the spindle motor using the fluid dynamic bearing according to the prior art, various problems such as scattering, or the like, of the operating fluid according to sealing of the operating fluid in the fluid dynamic bearing have been generated. Particularly, an interface of the operating fluid, that is, an oil interface in the case in which oil is used as the operating fluid is significantly vulnerable to external impact, and the operating fluid is leaked to the outside due to impact, or the like, during operation. The leakage of the operating fluid deteriorates operating performance of the motor, thereby causing a serious problem such as deterioration in reliability of the motor operation.

### SUMMARY OF THE INVENTION

The present invention has been made in an effort to provide a spindle motor in which oil sealing parts are surface-treated stepwise with respect to oil used as a fluid dynamic bearing, such that sealing of the oil sealing part is enhanced, thereby preventing scattering, or the like, of the oil.

According to a preferred embodiment of the present invention, there is provided a spindle motor including; a shaft; a sleeve supporting the shaft; oil provided between the shaft and the sleeve; a hub coupled to the shaft; a sealing member formed to be spaced apart from an outer peripheral surface of the sleeve; and an oil sealing part including an oil interface formed between the outer peripheral surface of the sleeve and an inner peripheral surface of the sealing member facing the outer peripheral surface of the sleeve, wherein a plurality of surface layers are sequentially formed on each of surfaces of the sleeve and the sealing member facing each other in a direction from an inner side of the oil interface of the oil sealing part toward an outer side thereof, and each of the plurality of surface layers has gradually reduced lipophilicity toward a direction in which each of the plurality of surface layers is formed.

In the plurality of surface layers, first surface layers and second surface layers may be sequentially formed, the first surface layers are made of a lipophilic material, and the second surface layers are made of an oil repellent material, which is not mixed with the lipophilic material.

The first surface layers may be made of urethane acryl or epoxy, and the second surface layers may be formed of a cured material layer made of a silicon based or fluorine based polymer.

In the plurality of surface layers, first surface layers, second surface layers, and third surface layers may be sequentially formed, the first surface layers may have lipophilicity higher than that of the second surface layers, and the second surface layers may have lipophilicity higher than that of the third surface layers.

The first surface layers may be made of a lipophilic material, the second surface layers may be formed on each of sides of an exposed sleeve and the sealing member facing each other, and the third surface layers may be made of an oil repellent material, which is not mixed with the lipophilic material.

The first surface layers may be made of urethane acryl or epoxy, which is the lipophilic material, and the third surface layers may be formed of a cured material layer made of a silicon based or fluorine based polymer, which is the oil repellent material.

The outer peripheral surface of the sleeve and the inner peripheral surface of the sealing member facing the outer peripheral surface of the sleeve may be in parallel with each other, having a spaced space therebetween.

In the plurality of surface layers, first surface layers and second surface layers may be sequentially formed, the first surface layers are made of a lipophilic material, and the second surface layers are made of an oil repellent material, which is not mixed with the lipophilic material.

The first surface layers may be made of urethane acryl or epoxy, and the second surface layers may be formed of a cured material layer made of a silicon based or fluorine based polymer.

In the plurality of surface layers, first surface layers, second surface layers, and third surface layers may be sequentially formed, the first surface layers may have lipophilicity higher than that of the second surface layers, and the second surface layers may have lipophilicity higher than that of the third surface layers.

The first surface layers may be made of a lipophilic material, the second surface layers may be formed on each of sides of an exposed sleeve and the sealing member facing each other, and the third surface layers may be made of an oil repellent material, which is not mixed with the lipophilic material.

The first surface layers may be made of urethane acryl or epoxy, which is the lipophilic material, and the third surface layers may be formed of a cured material layer made of a silicon based or fluorine based polymer, which is the oil repellent material.

### BRIEF DESCRIPTION OF THE DRAWINGS

FIG. 1 is a cross-sectional view of a spindle motor according to a first preferred embodiment of the present invention;

FIG. 2 is an enlarged view of a three-step surface layer formed in an oil sealing part in the first preferred embodiment of the present invention;

FIG. 3 is an enlarged view of a two-step surface layer formed in the oil sealing part in the first preferred embodiment of the present invention;

FIG. 4 is a cross-sectional view of a spindle motor according to a second preferred embodiment of the present invention;

FIG. 5 is an enlarged view of a three-step surface layer formed in an oil sealing part in the second preferred embodiment of the present invention;

FIG. 6 is an enlarged view of a two-step surface layer formed in the oil sealing part in the second preferred embodiment of the present invention;

FIGS. 7A to 7C are views showing a difference in contact angle formed by oil and oil contact surfaces due to a relative difference in lipophilicity of surface layers;

FIGS. 8A and 8B are views showing a moving path of oil on two surfaces having different surface energies according to the present invention; and

FIGS. 9A and 9B are views showing a moving path of oil between two members having different surface energies and facing each other according to the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, in the specification, an “axial direction” refers to a vertical direction based on a shaft 11, which is a component 11 of the present invention. In addition, the terms “one side”, “the other side”, “first”, “second”, and so on are used to distinguish one element from another element, and the elements are not defined by the above terms. In describing the present invention, a detailed description of related known functions or configurations will be omitted so as not to obscure the gist of the present invention.

Hereinafter, preferred embodiments of the present invention will be described in detail with reference to the accompanying drawings.

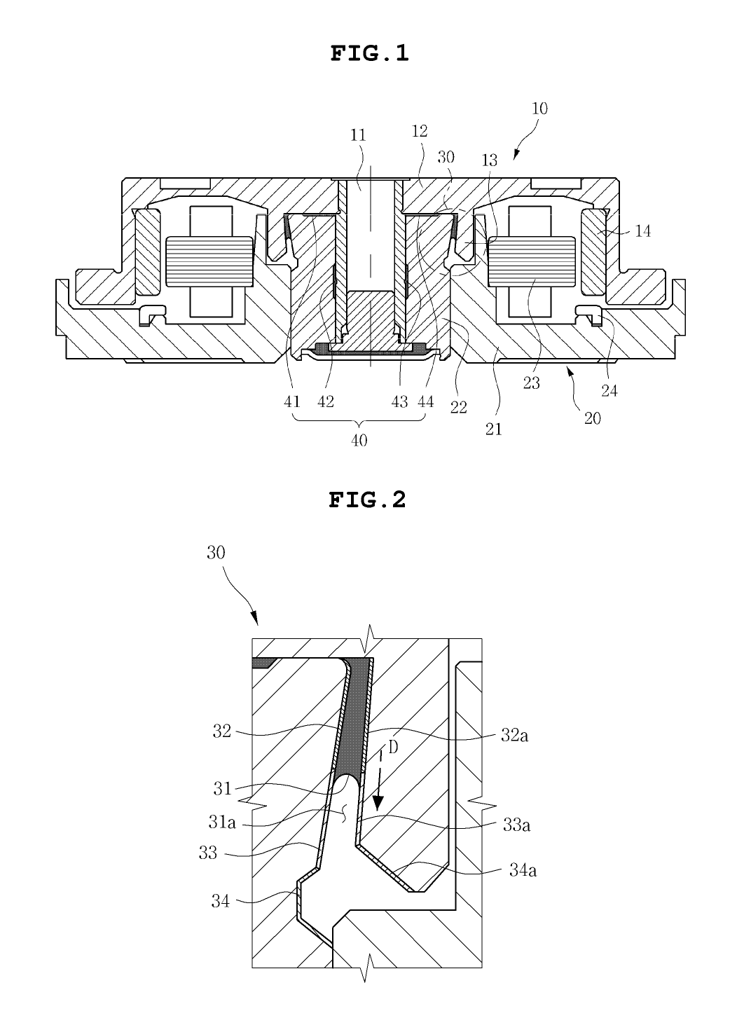

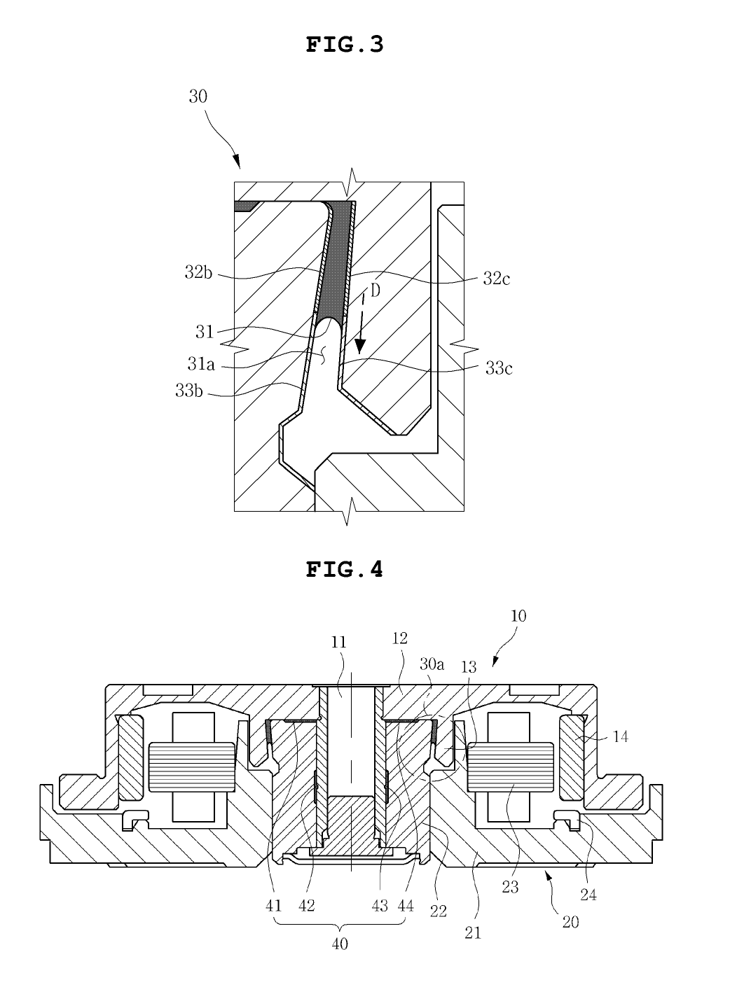

FIG. 1 is a cross-sectional view of a spindle motor according to a first preferred embodiment of the present invention; FIG. 2 is an enlarged view of a three-step surface layer formed in an oil sealing part 30 in the first preferred embodiment of the present invention; and FIG. 3 is an enlarged view of a two-step surface layer formed in the oil sealing part 30 in the first preferred embodiment of the present invention.

The spindle motor according to the first preferred embodiment of the present invention is configured to include a shaft 11, a sleeve 22 supporting the shaft 11, oil provided between the shaft 11 and the sleeve 22, a hub 12 coupled to the shaft 11, a sealing member 13 formed to be spaced apart from an outer peripheral surface of the sleeve 22, and an oil sealing part 30 including an oil interface 31 formed between the outer peripheral surface of the sleeve 22 and an inner peripheral surface of the sealing member 13 facing the outer peripheral surface of the sleeve 22, wherein a plurality of surface layers are sequentially formed on each of surfaces of the sleeve 22 and the sealing member 13 facing each other in a direction from an inner side of the oil interface 31 of the oil sealing part 30 toward an outer side thereof, and each of the plurality of surface layers has gradually reduced lipophilicity toward a direction in which it is formed.

The shaft 11, which forms a rotational axis according to rotation of the spindle motor, is coupled to the hub 12 to be described below to thereby configure a rotor 10.

The sleeve 22 may support the shaft 11 and be provided with a fluid dynamic bearing part 40 by operating fluid. The sleeve 22 may include a coupling hole (not shown) formed therein so as to be coupled to the shaft 11, and the shaft 11 may be insertedly coupled to the coupling hole The shaft 11 is insertedly coupled to the coupling hole, such that the fluid dynamic bearing part 40 by operating fluid may be formed in a contact surface between an inner surface of the coupling hole of the sleeve 22 and an outer surface of the shaft 11. More specifically, thrust bearing parts 42 and 44 in an axial direction may be formed. A coupling scheme between the shaft 11 and the sleeve 22 is not necessarily limited thereto. That is, various coupling structures may be used as long as the shaft 11 may be rotatably coupled to the sleeve 22 and form the fluid dynamic bearing part 40.

The hub 12 is coupled to the shaft 11. The hub 12 may serve to press the sleeve 22 while being coupled to the shaft 11. The hub 12 may includes the sealing member 13 to be described below extended therefrom and formed integrally therewith. Radial bearing parts 41 and 43 by fluid dynamic pressure may be formed in a contact surface between the hub 12 and the sleeve 22.

The oil sealing part 30 includes the oil interface 31 formed between one surface of the sleeve 22 and one surface of the sealing member 13 facing one surface of the sleeve 22. As the operating fluid, materials other than oil may be used. However, a case in which the oil or operating fluid having the same or similar property to that of the oil is used will be described in the present invention. The oil sealing part 30 may be formed in the axial direction. However, the oil sealing part 30 is not necessarily limited to being formed in the axial direction but may also be formed in a direction perpendicular to the axial direction according to a shape thereof.

The present invention will be described based on an example in which the oil sealing part 30 is formed in the axial direction as shown in FIGS. 1 to 3. The oil is filled in a spaced space formed from one side of the sleeve 22 and the oil interface 31 is formed, such that the oil sealing part 30 is formed. The spaced space of the oil sealing part 30 in which the oil is filled may be formed by one side of the sleeve 22 and a separate sealing member 13 facing one side of the sleeve 22. Here, the sealing member 13 formed by forming an axial protrusion part integrally with the hub 12 may configure the oil sealing part 30. Alternatively, a separate sealing member 13 coupled to the hub 12 may configure the oil sealing part 30. According to the first preferred embodiment of the present invention, as shown in FIGS. 1 and 2, the oil sealing part 30 is formed in a structure in which a width of the spaced space becomes larger toward a lower portion thereof in the axial direction, and the plurality of surfaces layers to be described below may be formed on each of sides of the sleeve 22 and the sealing member 13 having the above-mentioned structure and facing each other. The above-mentioned tapered shape may allow sealing to be performed using a capillary phenomenon that oil is collected in a narrow gap. However, it is difficult to prevent scattering or flow-down of the oil due to external impact or various impacts during an operation using only this type of sealing.

Therefore, in the present invention, multi-step surface layers according to the present invention are formed on surfaces of two members having the oil sealing part 30 formed therebetween and facing each other to increase a sealing effect, thereby improving performance and reliability of an operation of the spindle motor.

The multi-step surface layers may be sequentially formed in a direction from the inner side of the oil interface 31 toward the outer side thereof on each of sides of the sleeve 22 and the sealing member 13 that form the spaced space in which the oil sealing part 30 is formed and face each other. Here, the direction from the inner side of the oil interface 31 toward the outer side thereof refers to a direction represented by an arrow D of FIG. 2. When the multi-step surface layers are formed, the multi-step surface layers may be formed from a contact surface of a portion in which the oil is filled based on the oil interface 31 or be formed a direction from a portion at which the oil interface 31 is formed toward an outer side thereof, as shown in FIG. 2. However, it is preferable that the surface layers are formed stepwise from each of sides of the sleeve 22 and the sealing member 13 contacted by the oil at the inner side of the oil interface 31 and facing each other. The multi-step surface layers are formed so that lipophilicity thereof becomes gradually lower toward the arrow direction D. A surface layer having high lipophilicity and a surface layer having low lipophilicity are formed, thereby making it possible to prevent destruction of the oil interface 31 or flow-down or scattering of the oil due to a relative difference in surface energy between the surface layer having the high lipophilicity and the surface layer having the low lipophilicity. The reason is that the oil may move to the surface layer having the high lipophilicity in order to be stabilized between surface layers in each step.

FIG. 2 is a view showing an example of a case in which first surface layers 32 and 32a, second surface layers 33 and 33a, and third surface layers 34 and 34a according to the present invention are formed. The first surface layers 32 and 32a may be formed on each of sides of the sleeve and the sealing member facing each other at the inner side of the oil interface 31, the second surface layers 33 and 33a may be formed continuously to the first surface layers in the vicinity of the oil interface 31, and the third surface layers 34 and 34a may be formed continuously to the second surface layers 33 and 33a. Here, positions at which the first surface layers 32 and 32a are formed are not limited as described above. However, the first surface layers 32 and 32a need to start at least from the portion at which the oil interface 31 is formed, and may also be formed from the inner side of the oil interface 31 up to a portion including the oil interface 31.

Since the first surface layers 32 and 32a are surface layers having lipophilicity higher than those of the second surface layers 33 and 33a and the third surface layers 34 and 34a, it is advantageous in terms of preventing scattering, or the like, of the oil to form the first surface layers 32 and 32a on the surfaces of the sleeve and the sealing member contacted by the oil at the inner side of the oil interface 31. The first surface layers 32 and 32a may be made of a material having the highest lipophilicity, and the second surface layers 33 and 33a may be formed to have lipophilicity relatively lower than that of the first surface layers 32 and 32a by exposing surfaces of members themselves such as the sleeve 22, and the like, forming the oil sealing part 30. The third surface layers 34 and 34a is made of an oil repellent material, such that the first surface layers 32 and 32a, the second surface layers 33 and 33a, and the third surface layers 34 and 34a may be formed to stepwise reduced lipophilicity.

The first surface layers 32 and 32a may be made of urethane acryl or epoxy, and the third surface layers 34 and 34a may be formed of a cured material layer made of a silicon based or fluorine based polymer, which is an oil repellent material. Various lipophilic and oil repellent materials may be used as long as they have lipophilicity or oil repellent. Alternatively, the first surface layers 32 and 32a, the second surface layers 33 and 33a, and the third surface layers 34 and 34a may be made of lipophilic materials. However, in this case, each of them may be made of materials having stepwise reduced lipophilicity.

As shown in FIG. 3, according to the present invention, only two-step surface layers including first surface layers 32b and 32c and second surface layers 33b and 33c may be formed. Here, the first surface layers 32b and 32c may be made of a lipophilic material and the second surface layers 33b and 33c may be made of an oil repellent material. Alternatively, the first surface layers 32b and 32c may be made of the lipophilic material and the second surface layers 33b and 33c may be formed by exposing surfaces of members themselves forming the oil sealing part 30. Alternatively, the first surface layers 32b and 32c may be formed by exposing surfaces of members themselves forming the oil sealing part 30 and the second surface layers 33b and 33c may be made of the oil repellent material.

Besides, multi-step surface layers are formed so as to have sequentially reduced lipophilicity in a direction from the inner side of the oil interface 31 toward the outer side thereof, thereby making it possible to accomplish an effect of the present invention.

Hereinafter, the reason why the flow-down or the scattering of the oil is prevented due to a difference in lipophilicity between the multi-step surface layers will be described.

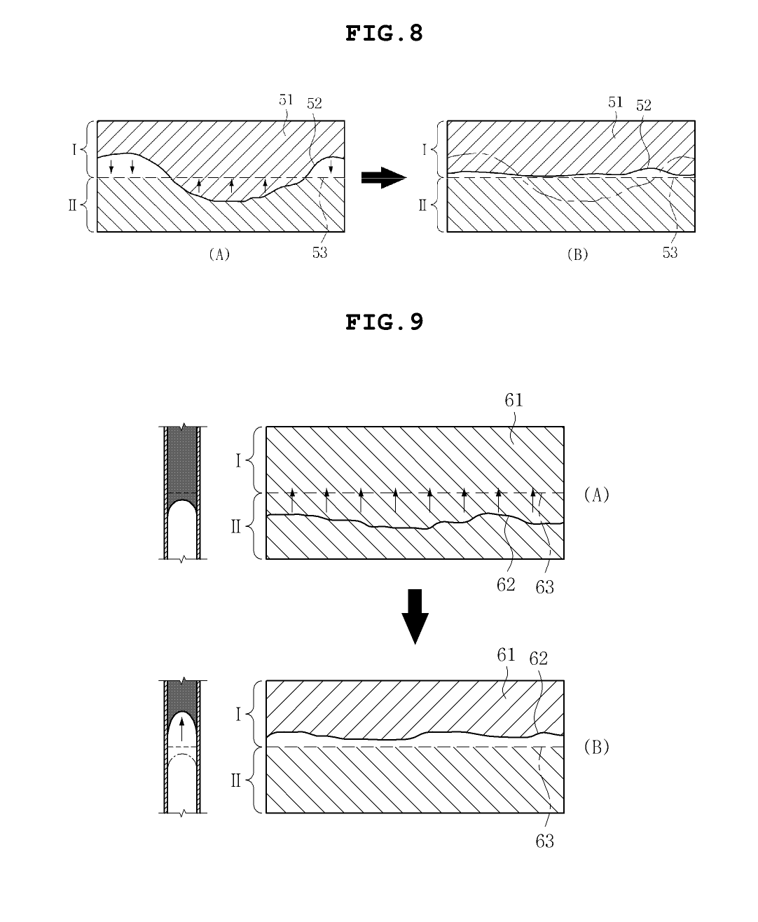

FIGS. 7A to 7C are views showing a difference in contact angle formed by oil and oil contact surfaces due to a relative difference in lipophilicity between surface layers 100, 200, and 300; FIGS. 8A and 8B are views showing a moving path of oil on two surfaces having different surface energies according to the present invention; and FIGS. 9A and 9B are views showing a moving path of oil between two members having different surface energies and facing each other according to the present invention.

FIGS. 7 to 9 are views describing a difference in surface energy due to the difference in lipophilicity and movement for stabilization of the oil according to the difference in surface energy. Particularly, the oil moves toward the oil interface 31 in accordance with properties that the oil is stabilized on the surface layers having a relative difference in surface energy, thereby making it possible to increase a sealing effect by the oil interface 31.

FIGS. 7A to 7C are, respectively, views showing a size of a contact angle between the oil and oil contact surfaces on the oil interface by forming each of surface layers 100 (See FIG. 7A), surface layers 200 (See FIG. 7B), and surface layers 300 (See FIG. 7C) each having different lipophilicity on the oil contact surfaces in the spaced space forming the oil sealing part 30. In FIGS. 7A to 7C, when each of the contact angles is a°, b°, and c°, sizes of each of the contact angles are a°<b°<c°. Magnitudes of the lipophilicity of the surface layers are FIG. 7A>FIG. 7B>FIG. 7C, and magnitudes of the surface energies are FIG. 7A>FIG. 7B>FIG. 7C. That is, it could be appreciated that as the lipophilicity increases, the surface energy relatively increases in proportion to the lipophilicity.

FIGS. 8A and 8B show a moving direction of oil by a relative difference in surface energy and a finally formed oil interface, respectively. A surface layer made of a material having relatively high surface energy is formed on an upper surface I of two surfaces, and a surface layer made of a material having relatively low surface energy is formed on a lower surface II thereof. As shown in FIG. 8A, at the beginning, the surface layer made of a material having relatively high surface energy, that is, a material having relatively high lipophilicity is formed on the upper surface I, and the surface layer made of a material having relatively low surface energy, that is, a material having relatively lower lipophilicity is formed on the lower surface II. hi this case, with the passage of time, as shown in FIG. 8B, it could be appreciated that oil 51 moves toward a direction in which the surface energy is relatively high, such that an oil interface 52 is formed in the vicinity of an energy boundary 53 between the upper surface I and the lower surface II. This is due to a property that a material is to be stabilized. That is, a relative difference in surface energy moves the oil in a direction in which the oil is stabilized.

FIGS. 9A and 9B are views showing a case in which when oil is filled between two members facing each other as in a structure of the oil sealing part 30 according to the present invention, the oil moves so as to be stabilized according to a relative difference in surface energy between facing surface layers of two members contacting the oil. Even in FIG. 9, a surface layer made of a material having relatively high surface energy, that is, relatively high lipophilicity is formed on an upper surface I, and a surface layer made of a material having relatively low surface energy, that is, relatively lower lipophilicity is formed on a lower surface II With the passage of time, oil 61 provided at a portion having relatively low surface energy in FIG. 9A moves to the surface layer of the upper surface I having relatively high surface energy as shown in FIG. 9B to thereby be stabilized. As a result, an oil interface 62 is formed in the vicinity of an energy boundary 63 between the upper surface I and the lower surface II.

As seen from FIG. 7A to 9B, the multi-step surface layers according to the present invention are formed to have different lipophilicity, thereby making it possible to prevent the oil interface 31 of the oil sealing part 30 or 30a according to the present invention from being destroyed.

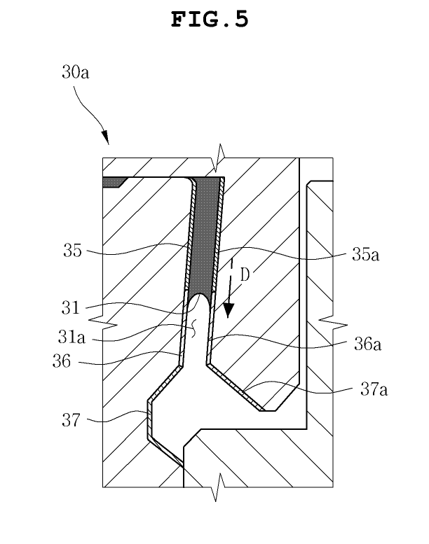

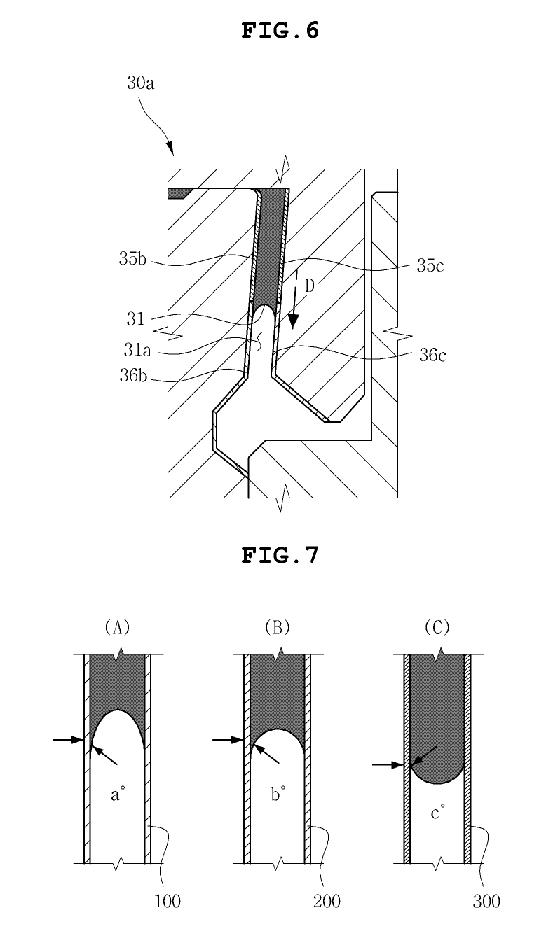

FIG. 4 is a cross-sectional view of a spindle motor according to a second preferred embodiment of the present invention; FIG. 5 is an enlarged view of a three-step surface layer formed in an oil sealing part 30a in the second preferred embodiment of the present invention; FIG. 6 is an enlarged view of a two-step surface layer formed in the oil sealing part 30a in the second preferred embodiment of the present invention.

The spindle motor according to the second preferred embodiment of the present invention is configured to include a shaft 11, a sleeve 22 supporting the shaft 11 and be provided with a fluid dynamic bearing part 40 by operating fluid, a hub 12 coupled to the shaft 11, a sealing member 13 formed to be spaced apart from one side of the sleeve 22, and an oil sealing part 30 including an oil interface 31 formed in a spaced space having a constant width between one side of the sleeve 22 and one side of the sealing member 13 facing one side of the sleeve 22, wherein a plurality of surface layers are sequentially formed on each of surfaces of the sleeve 22 and the sealing member 13 facing each other in a direction from an inner side of the oil interface 31 of the oil sealing part 30 toward an outer side thereof, and each of the plurality of surface layers has gradually reduced lipophilicity toward a direction in which it is formed.

The spindle motor according to the second preferred embodiment of the present invention has a feature particularly in a shape of the oil sealing part 30a. That is, as shown in FIGS. 4 and 5, a space spaced from one side of the sleeve 22 has a predetermined width. The sealing of the oil sealing part 30a may be performed using a capillary phenomenon that the oil is collected in a narrow gap through a tapered shape of the oil sealing part 30a shown in FIG. 2. However, according to the present invention, the oil sealing part 30a needs not necessarily to have the tapered shape. The reason is that a plurality of surface layers are formed stepwise based on a portion at which the oil interface 31 is formed and a difference in surface energy due to a relative difference in lipophilicity between the surface layers is used, such that the oil interface 31 may be maintained according to stabilization tendency of the oil. Therefore, as shown in FIG. 4, a spaced space of the oil sealing part 30a may be formed to have a parallel width in an axial direction. Although not shown, the oil sealing part 30a may be formed in a direction perpendicular to the axial direction. In this case, a space into which oil is injected to form an oil interface may be formed to have a constant width.

In the second preferred embodiment of the present invention, since first surface layers 35 and 35a, second surface layers 36 and 36a, and third surface layers 37 and 37a in the case in which three-step surface layers are formed and the first surface layers 35b and 35c and the second surface layers 36b and 36c in the case in which two-step surface layers are formed are the same as those in the first preferred embodiment of the present invention, descriptions thereof will be omitted.

Since the oil sealing part 30a, the multi-step surface layers, and the like, in the second preferred embodiment of the present invention are overlapped with that in the first preferred embodiment of the present invention, detailed descriptions thereof will be omitted.

The oil sealing parts 30 and 30a formed in the first and second preferred embodiments of the present invention may be formed by forming one side of the sleeve 22 and one side of the sealing member 13 extended from the hub 12 so as to correspond to each other, as shown in FIGS. 1 to 4. The sealing member 13 may be formed integrally with the hub 12 as shown in FIGS. 1 to 4. Alternatively, the sealing member 13 may be formed separately from the hub 12. In addition, although the present invention describes that the oil sealing part 30 or 30a is formed in the axial direction by way of example, the oil sealing part 30 or 30a may also be formed in a direction perpendicular to the axial direction by a separate sealing member 13. Even in this case, the multi-step surface layers according to the present invention are formed in a direction from the inner side of the oil interface toward the outer side thereof based on the oil interface, thereby making it possible to prevent the destruction of the oil interface and increase the sealing effect of the oil sealing part 30 or 30a.

Simply describing an operation relationship according to the present invention, the rotor 10 includes the shaft 11 that becomes a rotational axis and is formed to rotate and the hub 12 having a magnet 14 attached thereto, and a stator 20 includes a base 21, the sleeve 22, a core 23, and a pulling plate 24. Each of the core 23 and the magnet 14 is attached to an outer side of the base 21 and an inner side of the hub 12 while facing each other. When a current is applied to the core 23, a magnetic flux is generated while a magnetic field is formed. The magnet 14 facing the core 23 includes repeatedly magnetized N and S poles to thereby form an electrode, corresponding to a variable electrode generated in the core 23. The core 23 and the magnet 14 generates repulsive force therebetween due to electromagnetic force caused by interlinkage of magnetic fluxes to rotate the hub 12 and the shaft 11 coupled to the hub 12, such that the spindle motor according to the preferred embodiment of the present invention is driven. In addition, in order to prevent floating at the time of driving of the motor, the pulling plate 24 is formed on the base 21 so as to correspond to the magnet 14 in an axial direction. Attractive force acts between the pulling plate 24 and the magnet 14, thereby making it possible to stably drive rotatably the motor.

According to the preferred embodiments of the present invention, the oil contact surfaces are surface-treated stepwise in the direction from the inner side of the oil interface formed in the oil sealing part of the fluid dynamic bearing part toward the outer side thereof, thereby making it possible to enhance maintenance of the oil interface.

In addition, the oil contact surfaces are surface-treated stepwise in the vicinity of the oil interface, thereby making it possible to prevent the flow-down or the scattering of the oil through a difference in surface energy between the oil contact surfaces.

Further, the oil contact surfaces are surface-treated stepwise in the vicinity of the oil interface and the oil sealing part has shapes other than the tapered shape in which it is extended downwardly in the axial direction, thereby making it possible to improve a degree of freedom in design of the oil sealing part.

Furthermore, the sealing effect of the oil sealing part is improved, thereby making it possible to improve operation performance of the spindle motor and reliability of operation.

Although the preferred embodiments of the present invention have been disclosed for illustrative purposes, they are for specifically explaining the present invention and thus a spindle motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A spindle motor comprising;
a shaft;
a sleeve supporting the shaft;
oil provided between the shaft and the sleeve;
a hub coupled to the shaft;
a sealing member formed to be spaced apart from an outer peripheral surface of the sleeve; and
an oil sealing part including an oil interface formed between the outer peripheral surface of the sleeve and an inner peripheral surface of the sealing member facing the outer peripheral surface of the sleeve,
wherein a plurality of surface layers are sequentially formed on each of surfaces of the sleeve and the sealing member facing each other in a direction from an inner side of the oil interface of the oil sealing part toward an outer side thereof, and each of the plurality of surface layers has gradually reduced lipophilicity toward a direction in which each of the plurality of surface layers is formed.

2. The spindle motor as set forth in claim 1, wherein in the plurality of surface layers, first surface layers and second surface layers are sequentially formed, the first surface layers are made of a lipophilic material, and the second surface layers are made of an oil repellent material, which is not mixed with the lipophilic material.

3. The spindle motor as set forth in claim 2, wherein the first surface layers are made of urethane acryl or epoxy, and the second surface layers are formed of a cured material layer made of a silicon based or fluorine based polymer.

4. The spindle motor as set forth in claim 1, wherein in the plurality of surface layers, first surface layers, second surface layers, and third surface layers are sequentially formed, the first surface layers have lipophilicity higher than that of the second surface layers, and the second surface layers have lipophilicity higher than that of the third surface layers.

5. The spindle motor as set forth in claim 4, wherein the first surface layers are made of a lipophilic material, the second surface layers are formed on each of sides of an exposed sleeve and the sealing member facing each other, and the third surface layers are made of an oil repellent material, which is not mixed with the lipophilic material.

6. The spindle motor as set forth in claim 5, wherein the first surface layers are made of urethane acryl or epoxy, which is the lipophilic material, and the third surface layers are formed of a cured material layer made of a silicon based or fluorine based polymer, which is the oil repellent material.

7. The spindle motor as set forth in claim 1, wherein the outer peripheral surface of the sleeve and the inner peripheral surface of the sealing member facing the outer peripheral surface of the sleeve are in parallel with each other, having a spaced space therebetween.

8. The spindle motor as set forth in claim 7, wherein in the plurality of surface layers, first surface layers and second surface layers are sequentially formed, the first surface layers are made of a lipophilic material, and the second surface layers are made of an oil repellent material, which is not mixed with the lipophilic material.

9. The spindle motor as set forth in claim 8, wherein the first surface layers are made of urethane acryl or epoxy, and the second surface layers are formed of a cured material layer made of a silicon based or fluorine based polymer.

10. The spindle motor as set forth in claim 7, wherein in the plurality of surface layers, first surface layers, second surface layers, and third surface layers are sequentially formed, the first surface layers have lipophilicity higher than that of the second surface layers, and the second surface layers have lipophilicity higher than that of the third surface layers.

11. The spindle motor as set forth in claim 10, wherein the first surface layers are made of a lipophilic material, the second surface layers are formed on each of sides of an exposed sleeve and the sealing member facing each other, and the third surface layers are made of an oil repellent material, which is not mixed with the lipophilic material.

12. The spindle motor as set forth in claim 11, wherein the first surface layers are made of urethane acryl or epoxy, which is the lipophilic material, and the third surface layers are formed of a cured material layer made of a silicon based or fluorine based polymer, which is the oil repellent material.
